(19) United States
(12) Patent Application Publication
(10) Pub. No.: US 2025/0100862 A1
(43) Pub. Date: Mar. 27, 2025

(54) AXIALLY-LOCKING SINGLE-HANDLE CAN OPENER

(71) Applicant: Gongping LUO, Guangdong (CN)

(72) Inventor: Gongping LUO, Guangdong (CN)

(21) Appl. No.: 18/610,177

(22) Filed: Mar. 19, 2024

(30) Foreign Application Priority Data
Sep. 22, 2023 (CN) 202322578130.0

(51) Int. Cl. B67B 7/70; B67B 7/46

(52) U.S. Cl. CPC B67B 7/32; B67B 2007/303

(57) ABSTRACT

Disclosed is axially-locking single-handle can opener, comprising a handle, a driving assembly and a cutting assembly, wherein a shaft sleeve, a hinge pin, a wedge sleeve and a wedge friction sheet, wherein one end of the driving gear rod is provided with a gear disc, and the other end extends outward through the handle; the wedge sleeve and the wedge friction sheet are sleeved on the extending section; a limiting hole is opened in the extending section, and the hinge pin is inserted into the limiting hole to limit the wedge friction sheet and the wedge sleeve; the shaft sleeve is sleeved on a middle portion of the driving gear rod, and is fixed with the handle; and a reset pressure spring is disposed between the shaft sleeve and the gear disc.

### CROSS-REFERENCE TO RELATED APPLICATION

This application claims the priority benefit of China application serial no. 202322578130.0, filed on Sep. 22, 2023. The entirety of the above-mentioned patent application is hereby incorporated by reference herein and made a part of this specification.

### BACKGROUND

### Technical Field

The present disclosure relates to the field of daily life tools, in particular to an axially-locking single-handle can opener.

### Description of Related Art

In daily life, there are many varieties of canned food, most of which are sealed with tinplate cans. When eating such canned food, it is necessary to use a cutter to cut the lid in order to take out the food. Therefore, there are can openers on the market, and the commonly used can openers are single-handle manual can openers, double-handle manual can openers and electric can openers.

According to the driving assembly in the existing single-handle manual can opener, it is driven to run axially by means of a reset pressure spring, a wedge hexagonal sleeve and the latch, so that the driving assembly and the cutting assembly bite together to lock and cut the can. However, the wedge hexagonal sleeve in this driving assembly is an integrated structure made of powder metallurgy, and the shaft sleeve is made by lathe machining, and the limit hole of the driving gear rod is processed by drilling machine, such as Chinese patent No. 202120154774.5, therefore, the overall manufacturing cost of the can opener is higher, and the accuracy is difficult to guarantee.

### SUMMARY

An object of the present disclosure is to provide an axially-locking single-handle can opener with low processing cost guaranteed precision and improved service life.

In order to solve the above technical problems, the technical solutions taken by the present disclosure are as followings.

An axially-locking single-handle can opener, comprising a handle, a driving assembly and a cutting assembly, wherein the driving assembly and the cutting assembly are respectively disposed at the handle and form a biting state; the driving assembly comprises a driving gear rod, a shaft sleeve, a hinge pin, a wedge sleeve and a wedge friction sheet, wherein one end of the driving gear rod is provided with a gear disc, and the other end extends outward through the handle; the wedge sleeve and the wedge friction sheet are sleeved on the extended section in turn; a limiting hole is formed in the extended section, and the hinge pin is inserted into the limiting hole to limit the wedge friction sheet and the wedge sleeve; the shaft sleeve is sleeved on a middle portion of the driving gear rod, and is fixed with the handle; and a reset pressure spring is disposed between the shaft sleeve and the gear disc.

In one of embodiments, the wedge sleeve is provided with two first stopper arms, and the wedge friction sheet is provided with two second stopper arms; the wedge friction sheet is stacked on the wedge sleeve, and the second stopper arm is attached with the first stopper arm; two sets of guide slopes are formed between the two second stopper arms, and two ends of the hinge pin are matched with the two sets of guide slopes respectively.

In one of embodiments, the cutting assembly comprises a fixed locking pin shaft, a cutter wheel and a supporting wheel; a mounting groove is formed in the handle, and the fixed locking pin shaft traverses the mounting groove; the cutter wheel and the supporting wheel are respectively sleeved on the fixed locking pin shaft and are positioned in the mounting groove; and the cutter wheel and the supporting wheel are made by stamping process respectively.

In one of embodiments, the shaft sleeve is provided with a flange that is clamped into a clamping groove in the handle to fixedly connect the shaft sleeve with the handle, and the shaft sleeve is made by stamping process.

In one of embodiments, the wedge sleeve is made by injection molding process, and the wedge friction sheet is made by stamping process.

In one of embodiments, the extended section of the driving gear rod is also provided with a rotary knob, and the rotary knob is sleeved on the wedge friction sheet and the wedge sleeve.

In one of embodiments, a washer is disposed between the rotary knob and the handle, and the washer sleeve is sleeved on the driving gear rod.

In one of embodiments, the limiting hole is a circular hole and is made by wire cutting process.

In one of embodiments, the driving gear rod, the shaft sleeve, the hinge pin, the wedge friction sheet, the fixed lock pin shaft, the cutter wheel and the supporting wheel are all made of stainless steel.

In one of embodiments, the handle is provided with an auxiliary positioning anchor ring, a functional piece and a functional arm.

### Beneficial Effects

According to the axially-locking single-handle can opener of the present disclosure, the existing one-piece wedge hexagonal sleeve made by powder metallurgy processing is split into the wedge sleeve and the wedge friction sheet of separated type, and the wedge sleeve and the wedge friction sheet are manufactured by adopting injection molding process and stamping process respectively, thereby effectively reducing the processing cost of the wedge sleeve and the wedge friction sheet, and ensuring their processing accuracy. Meanwhile, the existing shaft sleeve that is processed by the lathe machining is changed to the shaft sleeve that is provided with flange and made by stamping process, and the existing cutting wheel is split into the cutter wheel and the supporting wheel of separated type that is made by stamping process, and finally combined with the limiting hole made by wire cutting, the overall processing cost of can opener can also be reduced, and it can greatly improve the processing accuracy and improve the service life of the can opener.

### BRIEF DESCRIPTION OF THE DRAWINGS

FIG. 1 is a structure diagram of the axially-locking single-handle can opener according to the present disclosure;

FIG. 2 is an exploded diagram of the axially-locking single-handle can opener according to the present disclosure;

FIG. 3 is a structure diagram of the driving gear rod of the axially-locking single-handle can opener according to the present disclosure;

FIG. 4 is a structure diagram of the wedge sleeve and the wedge friction sheet of the axially-locking single-handle can opener according to the present disclosure;

FIG. 5 is a diagram of unlocking of the axially-locking single-handle can opener according to the present disclosure;

FIG. 6 is a diagram of locking of the axially-locking single-handle can opener according to the present disclosure;

As shown in the drawings:
100: Handle, 110: Mounting groove, 120: auxiliary positioning anchor ring, 130: Functional piece, 140: Functional arm,
200: Driving assembly, 210: Driving gear rod, 211: Gear disc, 212: Limiting hole, 220: Shaft sleeve, 230: Hinge pin, 240: Wedge sleeve, 241: First stopper arm, 250: Wedge friction sheet, 251: Second stopper arm, 252: Guide slope, 260: Reset pressure spring, 270: Washer, 280: rotary knob,
300: Cutting assembly, 310: Fixed locking pin shaft, 320: Cutter wheel, 330: Supporting wheel.

### DESCRIPTION OF THE EMBODIMENTS

In order to make the above purpose, features and advantages of the present disclosure more obvious and easier to understand, the specific embodiments of the present disclosure will be described in detail in the following in conjunction with the accompanying drawings. In the following description, many specific details are elaborated in order to fully understand the present disclosure. However, the present disclosure may be implemented in many other ways different from those described herein, and those skilled in the art may make similar improvements without violating the content of the present disclosure, so the present disclosure is not limited by the specific embodiments disclosed below.

It should be noted that when a component is said to be “fixed” to another component, it can be directly on top of another component or other components can exist in between. When a component is considered to be “connected” to another component, it can be directly connected to another component or other components can exist in between at the same time. Conversely, when a component is described as “directly on” another component, there is no intermediate component. The terms “vertical”, “horizontal”, “left”, “right” and similar expressions used herein are for illustrative purposes only.

Unless otherwise defined, all technical and scientific terms used herein have the same meaning as those normally understood by those skilled in the technical art of the present disclosure. The terms used in the specification of the present disclosure herein are only for the purpose of describing specific embodiments, and are not intended to limit the present disclosure. As used herein, the terms “and/or” include any and all combinations of one or more related items listed.

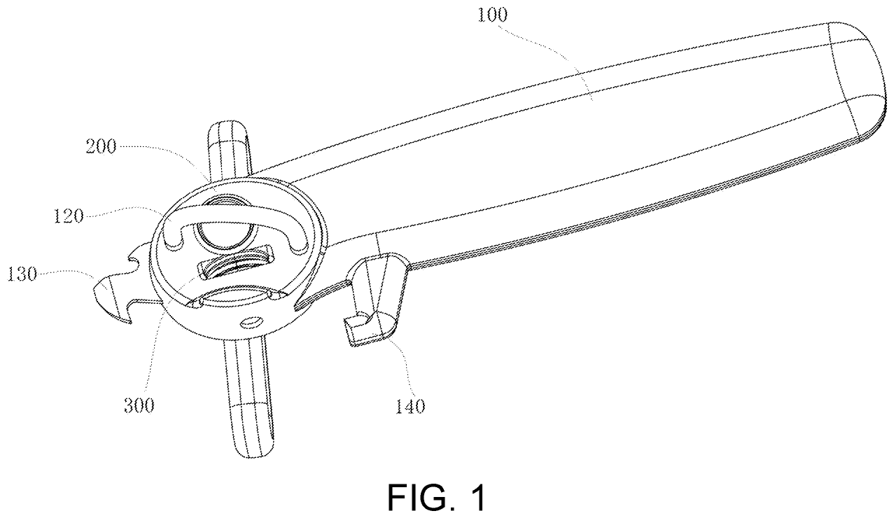

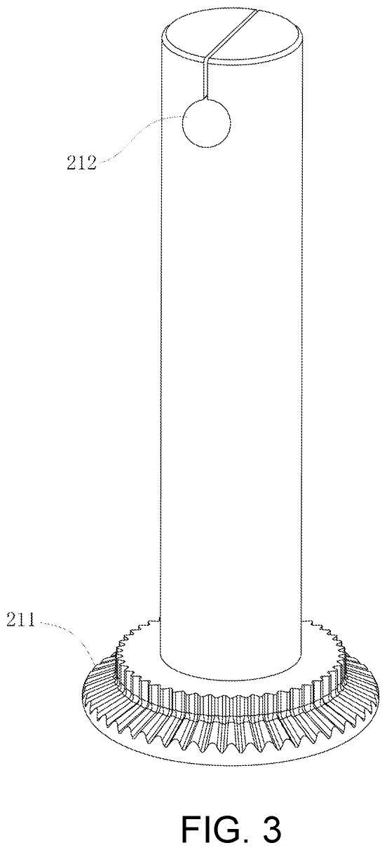

Referring to FIGS. 1-6, which show an axially-locking single-handle can opener comprising a handle 100, a driving assembly 200 and a cutting assembly 300. The driving assembly 200 and the cutting assembly 300 are respectively disposed at the handle 100 and form a biting state. The driving assembly 200 comprises a driving gear rod 210, a shaft sleeve 220, a hinge pin 230, a wedge sleeve 240 and a wedge friction sheet 250. One end of the driving gear rod 210 is provided with a gear disc 211, and the other end extends outward through the handle 100. The wedge sleeve 240 and the wedge friction sheet 250 are sleeved on the extended section in turn. A limiting hole 212 is formed in the extended section, and the hinge pin 230 is inserted into the limiting hole 212 to limit the wedge friction sheet 250 and the wedge sleeve 240. The shaft sleeve 220 is sleeved on a middle portion of the driving gear rod 210, and is fixed with the handle 100. A reset pressure spring 260 is disposed between the shaft sleeve 220 and the gear disc 211.

Specifically, in this embodiment, the existing one-piece wedge hexagonal sleeve made by precision casting process is split into a split wedge sleeve 240 and a wedge friction sheet 250 of the separated type. The wedge sleeve 240 and the wedge friction sheet 250 are processed respectively, and the wedge sleeve 240 is made by injection molding processing technology, and the wedge friction sheet 250 is made by stamping processing technology, so that the processing of the separated type of wedge sleeve 240 and the wedge friction sheet 250 can be more convenient and simple, and the processing cost of the wedge sleeve 240 and the wedge friction sheet 250 can be reduced, meanwhile the processing accuracy is ensured, and the overall cost of the can opener is reduced.

And when cutting and opening the canned product, the user holds the handle 100, and makes the cutting assembly 300 cooperate with the driving assembly 200 to bite the can cover. After biting together, the driving gear rod 210 is rotated. When rotating, the hinge pin 230 and the wedge friction sheet 250 can run relatively, so that the driving gear rod 210 moves axially, thereby the biting distance between the cutting assembly 300 and the driving assembly 200 is reduced, and the can cover is locked. The driving gear rod 210 continues to be rotated after that, so that the cutting assembly 300 cuts around the can cover until the cutting is completed. The can cover can be directly removed by the biting between the cutting assembly 300 and the driving assembly 200. Then reverse the rotation of the driving gear rod 210, make hinge pin 230 and wedge friction sheet 250 run in reverse, and make the driving gear rod 210 to reset by the reset pressure spring 260, so that the biting distance between the driving assembly 200 and the cutting assembly 300 increases and reset, thereby the cut-out can cover is conveniently to be dropped off.

In addition, the wedge sleeve 240 and the wedge friction sheet 250 in this embodiment both have hexagonal structure, and in order to facilitate the rotation of the driving gear rod 210, a rotary knob 280 is further disposed at the extension end of the driving gear rod 210, and the rotary knob 280 is socketed with the wedge sleeve 240 and the wedge friction sheet 250. The rotary knob 280 is also provided with a hexagonal connecting hole. By inserting the hexagonal wedge sleeve 240 and the hexagonal wedge friction sheet 250 into the hexagonal connecting hole of the rotary knob 280, the wedge sleeve 240 and the wedge friction sheet 250 can be connected with the rotary knob 280, and the driving gear rod 210 can be conveniently rotated by means of the rotary knob 280.

Of course, in order to reduce the abrasion between the rotary knob 280 and the handle 100, a washer 270 is also disposed between the rotary knob 280 and the handle 100, and the washer 270 is sleeved at the driving gear rod 210. The abrasion that the rotary knob 280 bring about when rotating can be effectively reduced through the washer 270, so as to improve the overall service life of the can opener.

And the limiting hole 212 in this embodiment is a circular hole. However, it is not limited to the circular hole, and other shapes can also be adopted. The circular limiting hole 212 is made by wire cutting, therefore, the limiting hole 212 can be conveniently processed, and the strength of the driving gear rod 210 is not affected, and meanwhile, the machining accuracy of the limiting hole 212 can also be ensured through the wire cutting process, and the cost is reduced.

Similarly, the shaft sleeve 220 is provided with a flange. The flange is clamped into the clamping groove in the handle 100, so that the shaft sleeve 220 can be conveniently fixedly connected with the handle 100, and the reset pressure spring 260 is conveniently assembled limitedly. The flange of the shaft sleeve 220 is made by stamping processing technology, so that the processing cost can be reduced, and the processing efficiency is improved.

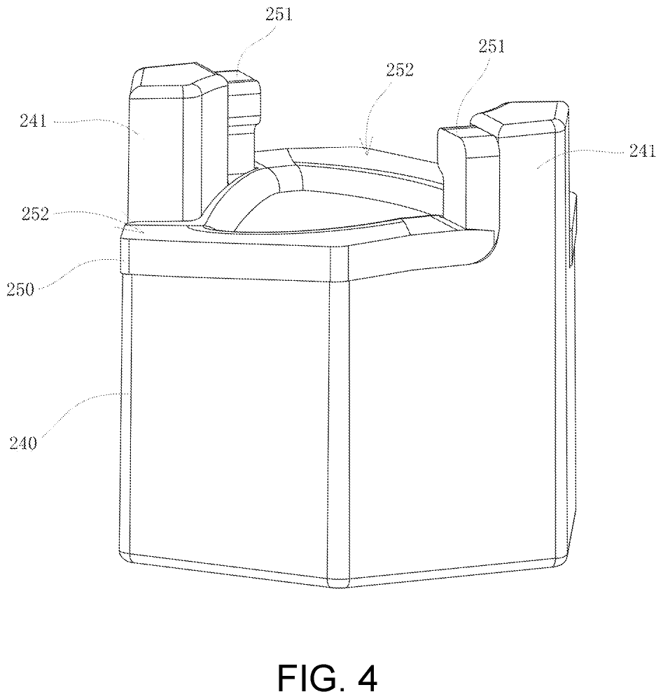

Referring to FIG. 4, in order to realize the axial running of the driving gear rod 210, the wedge sleeve 240 is provided with two first stopper arms 241, and the wedge friction sheet 250 is provided with two second stopper arms 251. During assembly, the wedge friction sheet 250 is stacked on the wedge sleeve 240, the second stopper arms 251 are attached with the first stopper arms 241, and two sets of guide slopes 252 are formed between the two second stopper arms 251. The two ends of the hinge pin 230 are matched with two sets of guide slopes 252 respectively. When the driving assembly 200 and the cutting assembly 300 are required to bite together and lock, the rotary knob 280 is rotated, and the rotary knob 280 then drives the wedge sleeve 240 and the wedge friction sheet 250 to rotate, so that the ends of the hinge pin 230 and the guide slopes 252 of the wedge friction sheet 250 are in contact from low to high, so that the driving gear rod 210 moves axially, the biting distance between the driving assembly 200 and the cutting assembly 300 is reduced, and the locking of the driving assembly 200 is realized. When it needs to be unlocked, the rotary knob 280 is rotated in reverse, the ends of the hinge pin 230 are in contact with the guide slopes 252 of the wedge friction sheet 250 from high to low, and the driving gear rod 210 is reset by the reset pressure spring 260, so that the biting distance between the driving assembly 200 and the cutting assembly 300 increases to unlock the driving assembly 200.

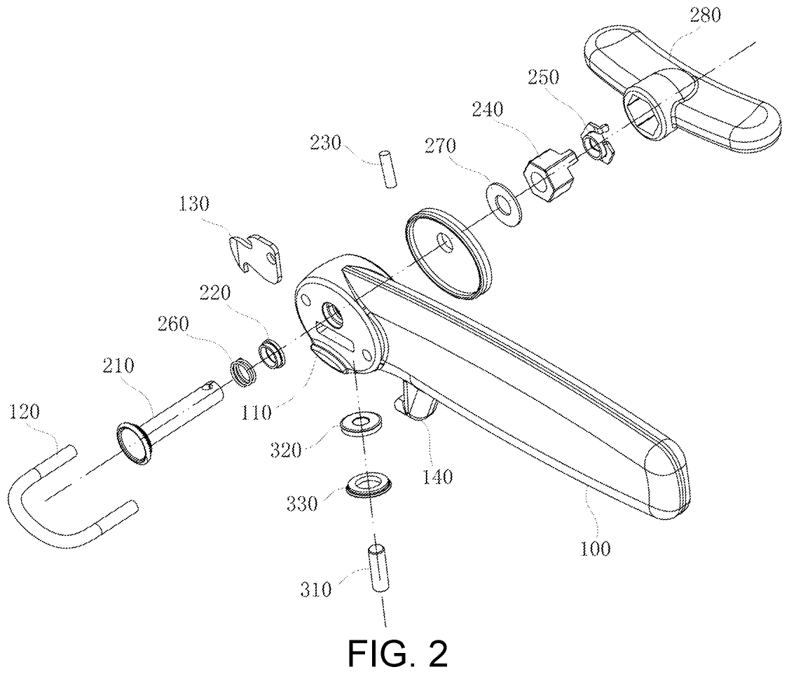

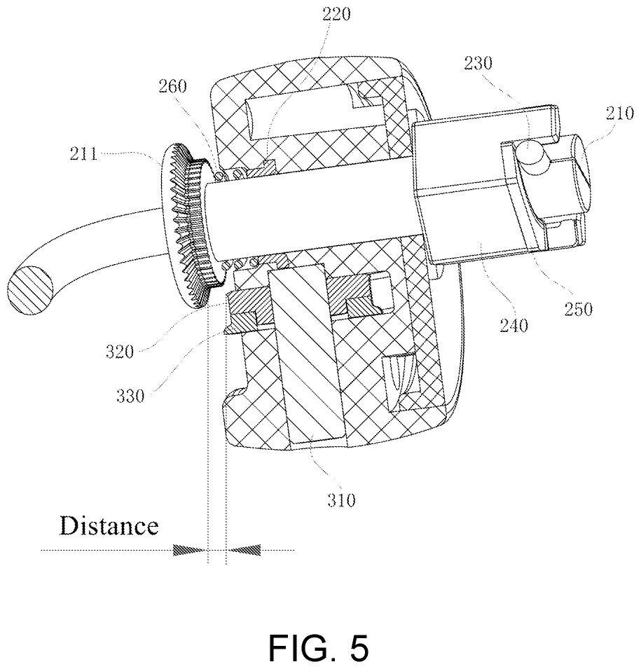

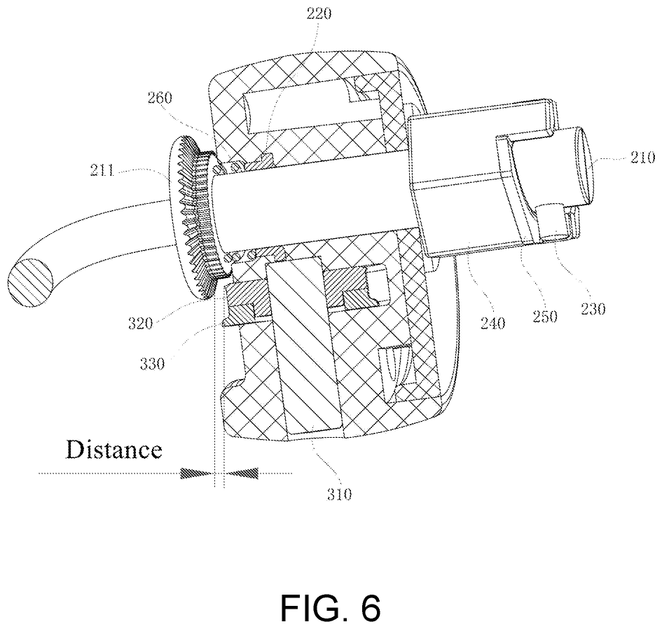

Referring FIG. 2, FIG. 5 or FIG. 6, in order to cut a canned product, the cutting assembly 300 in this embodiment comprises a fixed locking pin shaft 310, a cutter wheel 320 and a supporting wheel 330. A mounting groove 110 is formed in the handle 100, and the fixed locking pin shaft 310 traverses the mounting groove 110. The cutter wheel 320 and the supporting wheel 330 are respectively sleeved on the fixed locking pin shaft 310 and are positioned in the mounting groove 110.

The supporting wheel 330 and the cutter wheel 320 are respectively disposed in the mounting groove 110 of the handle 100, and are fixed by the fixed locking pin shaft 310, and the cutter wheel 320 is matched with the gear disc 211 at the end of the driving gear rod 210, so that the cutting of the can cover is realized. Meanwhile, the original cutter wheel is split into the cutter wheel 320 and the supporting wheel 330 of separated type, and the cutter wheel 320 is processed firstly by stamping and then by lathe, so that the processing of the cutter wheel 320 can be convenient, and the processing cost is reduced, and the processing efficiency is improved.

Finally, referring to FIG. 1 or FIG. 2, in order to increase the functionality of the can opener, the handle 100 is provided with an auxiliary positioning anchor ring 120, a functional piece 130 and a functional arm 140. The auxiliary positioning anchor ring 120 can help the cutting of the can cover. The end of the functional piece 130 can be used for prying the cover of the milk powder can, the arc groove on one side can be used as the bottle opener, and the retractor on the other side can be used for the pull ring of Cola (can) and the like. The functional arm 140 can be used for prying the cover of the glass can loose. The overall functionality of the can opener can be improved by the auxiliary positioning anchor ring 120, the functional piece 130 and the functional arm 140.

Because the parts of the existing cutting assembly 300 and the driving assembly 200 are made of iron, and carburizing processing, and then electroplating, which is easy to peel, and the service life is short. Hence in this embodiment, the driving gear rod 210, the shaft sleeve 220, the hinging pin 230 and the wedge friction sheet 250 and the cutting assembly 300 in the driving assembly 200 are all made of stainless steel, so that the overall service life of the can opener can be improved.

The above shows and describes the basic principles and main features of the present disclosure and the advantages of the present disclosure. All technicians in the art may smoothly implement the disclosure as shown in the drawings attached to the specification and as described above. However, all technical personnel familiar with the present specialty, without departing from the scope of the technical solution of the present disclosure, using the technical content disclosed above to make some changes, modifications and equivalent changes in evolution, are equivalent embodiments of the present disclosure. At the same time, any equivalent changes, modifications and evolution of the above embodiments made according to the substantive technology of the present disclosure are still within the scope of protection of the technical solution of the present disclosure.

What is claimed is:

1. An axially-locking single-handle can opener, comprising a handle, a driving assembly and a cutting assembly, wherein the driving assembly and the cutting assembly are respectively disposed at the handle and form a biting state;
the driving assembly comprises a driving gear rod, a shaft sleeve, a hinge pin, a wedge sleeve and a wedge friction sheet, wherein one end of the driving gear rod is provided with a gear disc, and the other end extends outward through the handle; the wedge sleeve and the wedge friction sheet are sleeved on the extended section in turn; a limiting hole is formed in the extended section, and the hinge pin is inserted into the limiting hole to limit the wedge friction sheet and the wedge sleeve; the shaft sleeve is sleeved on a middle portion of the driving gear rod, and is fixed with the handle; and a reset pressure spring is disposed between the shaft sleeve and the gear disc.

2. The axially-locking single-handle can opener according to claim 1, wherein the wedge sleeve is provided with two first stopper arms, and the wedge friction sheet is provided with two second stopper arms; the wedge friction sheet is stacked on the wedge sleeve, and the second stopper arm is attached with the first stopper arm; two sets of guide slopes are formed between the two second stopper arms, and two ends of the hinge pin are matched with the two sets of guide slopes respectively.

3. The axially-locking single-handle can opener according to claim 1, wherein the cutting assembly comprises a fixed lock pin shaft, a cutter wheel and a supporting wheel; a mounting groove is formed in the handle, and the fixed lock pin shaft traverses the mounting groove; the cutter wheel and the supporting wheel are respectively sleeved on the fixed lock pin shaft and are positioned in the mounting groove; and the cutter wheel and the supporting wheel are made by stamping process respectively.

4. The axially-locking single-handle can opener according to claim 1, wherein the shaft sleeve is provided with a flange that is clamped into a clamping groove in the handle to fixedly connect the shaft sleeve with the handle, and the shaft sleeve is made by stamping process.

5. The axially-locking single-handle can opener according to claim 1, wherein the wedge sleeve is made by injection molding process, and the wedge friction sheet is made by stamping process.

6. The axially-locking single-handle can opener of claim 1, wherein the extended section of the driving gear rod is also provided with a rotary knob, and the rotary knob is sleeved on the wedge friction sheet and the wedge sleeve.

7. The axially-locking single-handle can opener of claim 6, wherein a washer is disposed between the rotary knob and the handle, and the washer sleeve is sleeved on the driving gear rod.

8. The axially-locking single-handle can opener according to claim 1, wherein the limiting hole is a circular hole and is made by wire cutting process.

9. The axially-locking single-handle can opener according to claim 3, wherein the driving gear rod, the shaft sleeve, the hinge pin, the wedge friction sheet, the fixed lock pin shaft, the cutter wheel and the supporting wheel are all made of stainless steel.

10. The axially-locking single-handle can opener according to claim 1, wherein the handle is provided with an auxiliary positioning anchor ring, a functional piece and a functional arm.
